(19) United States
(12) Patent Application Publication
(10) Pub. No.: US 2008/0282079 A1
(43) Pub. Date: Nov. 13, 2008

(54) System and method for ad-hoc processing of cryptographically-encoded data

(76) Inventors: Karim Yaghmour, Sherbrooke (CA); Mathieu Lemay, Sherbrooke (CA)

Correspondence Address: JACOBSON HOLMAN PLLC, 400 SEVENTH STREET N.W., SUITE 600, WASHINGTON, DC, 20004, US

(21) Appl. No.: 12/149,533

(22) Filed: May 2, 2008

(30) Foreign Application Priority Data
May 2, 2007 (CA) 2,587,239

(51) Int. Cl. H04L 9/32; H04L 9/00

(52) U.S. Cl. 713/150

(57) ABSTRACT

The present disclosure provides a system and method for ad-hoc processing of cryptographically-encoded data. In one embodiment, a recipient receives a cryptographically-encoded email and proceeds to contact a processing server to decrypt said cryptographically-encoded email. The recipient may interact with the server either by copying-and-pasting the content of the cryptographically-encoded email to a web interface provided by the processing server or by forwarding it to the processing server using his existing email software. In the case of the forward, the processing server sends yet another email back to the recipient containing a URL to a web interface for continuing to interact with the processing server in order to decrypt the cryptographically-encoded email. Through its web interface, the processing server guides the recipient through the steps required to view a decrypted version of the cryptographically-encoded email.

This application is related to Canada Application No. 2,587,239, titled “System and Method for Ad-Hoc Processing of Cryptographically-Encoded Data,” filed on May 2, 2007, the entire contents of which are incorporated herein by reference.

### FIELD OF INVENTION

The present disclosure relates to data processing and, more particularly, to a method and apparatus for the ad-hoc processing of cryptographically-encoded data by means of software already available at a data processing site. In the case of email, for example, an embodiment of this disclosure describes a system and method for processing cryptographically-encoded email without requiring a user to install additional software on his workstation. Similar embodiments can be envisioned for other applications such as, but not limited to, instant messaging and GSM SMS.

### BACKGROUND

Parties involved in exchanging data are increasingly aware of the need to ensure the integrity and security of their communication channel. Basic reasons for doing this include authenticating data's origin and protecting data from being accessed by unauthorized parties.

Electronic mail (“e-mail” or “email”), which is a prime example of such a communication channel, has become a critical means of communication for a large number of organizations, businesses and individuals. Its simplicity, efficiency, and, most importantly, its virtually inexistent cost have made it very popular. That being said, standard email is inherently insecure, untraceable and unauthenticated. A wide variety of solutions have been proposed to address these and other issues. Examples of such proposed solutions may be found in co-pending “System and Method for Warranting Electronic Mail Using a Hybrid Public Key Encryption Scheme” assigned PCT International Publication Number WO 2005/078993, “System and Method for Providing Certified Proof Of Delivery Receipts for Electronic Mail” assigned PCT International Publication Number WO 2007/071040 and “System and Method for End-To-End Electronic Mail Encryption” assigned PCT International Publication Number WO 2007/071041 the entire contents of which are expressly herein incorporated by reference.

While some solutions are in fact effective in solving some of email's shortcomings, those most effective often require both senders and recipients to use software add-ons or plugins to their existing email software. In practice, however, while one of the communicating parties may have the appropriate tools to protect his end of the channel, the other party often lacks such tools. Even when the other party has such tools at his disposal, said tools may be incompatible with those used by the first party.

Compatibility issues are especially problematic when cryptographic means are used to harden the email communication channel since both parties must be using cryptographically-compatible software. Given that there is a wide range of email applications, such compatibility is difficult to achieve. For example, a sender may be using a regular email application such as Microsoft Outlook® while a recipient may be using a webmail service such as Yahoo!® Mail or Google's® Gmail. The former may be able to easily install a plugin for his email application while the latter cannot easily be provided with a plugin for his email interface since said interface is very strictly controlled by his email service provider and is only typically accessible to the user through a web browser. Even in the case where both sender and recipient are using a regular email client application, one may be able to install a plugin, or has one already installed, while the other may not desire or even have the proper operating system privileges required to install such software or is otherwise unable to use an appropriate plugin. To address these issues, a wide number of solutions have been proposed.

Intermediary Storage Gateway or Staging Server (Secure Email “Pull”)

In this method, the sender sends his emails to the recipient through a special server or provider, the latter stores the original email and sends a notification to the end recipient, usually in the form of another email, to the effect that an email is stored for him by the underlying system and provides instructions as to how to retrieve the email. Typically the recipient accesses the email sent to him by the sender by clicking on a URL link included in the notification email, which automatically launches a web browser with the designated URL. The sender may initiate this process either manually by selecting a special sending procedure different from the one typically used for sending his regular email or the process may be initiated by a server through which outbound emails transit, said server being configured for automatically “securing” outbound emails that match a certain number of criteria.

While the above-described method allows the sender to send secure emails to a recipient without requiring the recipient to have additional software on his workstation to decrypt the email, since web browsers are widely available, there are several shortcomings to this solution. Firstly, it often requires changes to the sender's infrastructure so that emails sent by him go through a special server or a special service provider or trusted third-party (TTP). Secondly, when a TTP's services are used, this requires senders to entrust their emails to a party over which they may have little or no oversight which, in turn, entails a number of security risks. Thirdly, this method requires that a large storage capacity be set aside on the staging server, whether it be run by the sender's organization or by a TTP, and, in the case of services offered by a TTP, requires the TTP to provision bandwidth for the upload of content by the sender and the download of the same content by the designated recipients. In the case of a TTP, therefore, the costs of operating such a service are high. Fourthly, and most importantly, it exposes recipients to phishing risks. Indeed, the recipients, lacking specialized software on their computer to verify the authenticity of the notification email, may be lured to malicious websites and asked to supply confidential information, such as a password or other forms of credentials, upon receiving a spoofed notification email that closely resembles, or that claims to be, the usual notification emails. This is especially true when an organization establishes this delivery mechanism as a habit with its recipients. The latter would therefore be easily fooled by a similar-looking notification email. Moreover, since many organizations are increasingly educating their members about phishing, some recipients who are not yet familiar with the security system employed by the sender may choose not to click on the link appearing in a legitimate notification email. Fifthly, there is the fact that this method is easily subverted by a man-in-the-middle (MITM) attack. Indeed, since the recipient cannot reliably authenticate the notification email's origin, nothing precludes an attacker from intercepting the original notification email, substituting it with a similar-looking email which redirects the recipient to a spoofed website which looks exactly as the one the recipient would usually see by clicking on the URL contained in the legitimate notification email but that is tailored for obtaining valid usernames and passwords from unsuspecting recipients and, therefore, allowing the attacker to illegitimately access secured content.

This method is the most commonly used at the time of this writing for solving the above mentioned compatibility problem in between senders and recipients. There are in fact quite a few products, vendors and software that implement this solution, including products from known vendors such as Tumbleweed and Entrust. Example detailed embodiments can be found in U.S. Pat. No. 6,192,407 and U.S. Pat. No. 5,790,790.

Self-Executing and/or Self-Contained Email and/or Attachments (Secure Email “Push”)

In this method, the secured email is sent in its entirety to the recipient. However, it is sent in a manor by which the recipient will not need any specialized software in order to process the encrypted email. In some cases, this means that the content is packaged as a self-executing attachment which will enable the recipient to automatically process the secured content once a certain number of steps, such as entering a proper username and password, have been properly followed. In the case of products marketed by Voltage Security, the recipient receives an email that contains an HTML attachment which, itself, contains the secure content within a form element and, therefore, when the recipient opens the attachment and enters appropriate information, the form content is automatically sent to a processing server which thereafter enables the recipient to access the secure content. As in the previously-described method, the present method may be selected manually by the sender at send time or it may be automatically triggered by a server through which the sender's outbound email transits.

While the use of self-executing or self-contained emails avoids the pitfalls of having to store content on a staging server for delivery to the recipient, it remains that the recipient can easily be fooled by receiving emails or attachments resembling the typical secure content he comes to expect from a given sender but that are in fact malicious. This approach is therefore subject to the same phishing and MITM attack problems of the previously-mentioned approach.

Implementations of this approach are not as widely used as the previously-mentioned one, but are often discussed in specialized literature side-by-side. Example detailed embodiments can be found in US 2005/0071632 and U.S. Pat. No. 6,014,688 along with subsequent U.S. Pat. No. 6,304,897 and US 2005/0021633.

Current Needs

There are also other existing and proposed methods. However, none of the existing methods fully solve the problem of allowing a sender to communicate securely and reliably with a multitude of recipients. There is, therefore, a need for a system and method allowing a sender and recipient to exchange emails containing cryptographically-processed data in an ad-hoc fashion while minimizing the software requirements on either side. More generally, there is therefore a need to ensure that parties be able to conduct ad-hoc yet secure email communications while minimizing the list of software components that must be compatible amongst them.

There is thus also a need for a mechanism for allowing recipient to access cryptographically-encoded data that is less likely to be exploitable by malicious third parties through phishing or MITM attacks. There is also a need for enabling the secure delivering of data to recipients without the sender having to modify his infrastructure and without having to manage the storage of the data until it is retrieved by recipients.

There is thus a need for a system and method for ad-hoc processing of cryptographically-encoded data wherein the existing email infrastructure remains unchanged, in as much as possible, and would therefore not be impacted, or be impacted as little as possible, by the use of such a system and method by the existing users. Furthermore, there is thus also a need for a system and method for ad-hoc processing cryptographically-encoded data that intuitively integrate into users' existing habits.

### SUMMARY OF THE INVENTION

An object of the present disclosure is to provide a system and method for ad-hoc processing of cryptographically-encoded data that overcome at least one of the previously listed drawbacks and that satisfy at least one of the above-mentioned needs.

Another object of the present disclosure is to provide a system and method for ad-hoc processing of cryptographically-encoded data that enables a sender and a recipient to exchange confidential information while minimizing potential software compatibility issues between both parties.

Another object of the present disclosure is to provide a system and method for ad-hoc processing of cryptographically-encoded data that enables a recipient to process a cryptographically-encoded email received from a sender without requiring additional software on said recipient's part.

Another object of the present disclosure is to provide a system and method for ad-hoc processing of cryptographically-encoded data that does not require the sender to modify his existing infrastructure.

Another object of the present disclosure is to provide a system and method for ad-hoc processing of cryptographically-encoded data wherein the initial deployment of the ad-processing functionality imposes no, or few, perturbations on the existing email infrastructure.

Another object of the present disclosure is to provide a system and method for ad-hoc processing of cryptographically-encoded data wherein the sender need not entrust their email for storage by a TTP.

Another object of the present disclosure is to provide a system and method for ad-hoc processing of cryptographically-encoded data wherein the scalability of the components part of the system and method does not depend, or depends in as little as possible, on the number of emails processed by said system or method.

Another object of the present disclosure is to provide a system and method for ad-hoc processing of cryptographically-encoded data wherein the permanent store for all cryptographically-encoded email sent to a recipient is that recipient's own existing email store.

Another object of the present disclosure is to provide a system and method for ad-hoc processing of cryptographically-encoded data that makes it difficult for malicious third parties to abuse said system and method, especially with regards to sender-instilled, easily-abusable habits.

Another object of the present disclosure is to provide a system and method for ad-hoc processing of cryptographically-encoded data that may not easily be abused by malicious third parties without providing an opportunity for the recipient to doubt the email's origin.

At least one of the preceding objects is met, in whole or in part, by the present disclosure, in which there is provided a system and method for ad-hoc processing of cryptographically-encoded data.

According to the present disclosure, there is provided a system for ad-hoc processing of cryptographically-encoded data, the system comprising:
a sender unit configured for sending cryptographically-encoded data;
a recipient unit configured for receiving data; and
a processing module operating remotely from the recipient unit, the processing module being configured for enabling the recipient unit to decrypt cryptographically-encoded data.

According to the present disclosure, there is also provided a system for ad-hoc processing of cryptographically-encoded email, the system comprising:
a sender station configured for sending a cryptographically-encoded email;
a recipient station configured for receiving email; and
a processing server operating remotely from the recipient station, the processing server being configured for enabling the recipient station to decrypt the cryptographically-encoded email.

According to the present disclosure, there is further provided a method for ad-hoc processing of cryptographically-encoded email, comprising the steps of:
a) receiving at a processing module a cryptographically-encoded email forwarded by a recipient unit;
b) storing the cryptographically-encoded email in temporary storage; and
c) sending an email to the recipient unit containing a link to a web page for processing the temporarily-stored cryptographically-encoded email.

According to the present disclosure, there is further provided a method for ad-hoc processing of cryptographically-encoded email, comprising the steps of:
a) providing at a processing module a web interface for a recipient unit to copy-and-paste a cryptographically-encoded email;
b) receiving a copied-and-pasted cryptographically-encoded email; and
c) decrypting the cryptographically-encoded email on behalf of the recipient unit.

According to the present disclosure, there is further provided an article of manufacture for processing a cryptographically-encoded email, wherein the article of manufacture causes operations, the operations comprising:
a) receiving a cryptographically-encoded email forwarded by a recipient station;
b) storing the cryptographically-encoded email in temporary storage; and
c) sending an email to the recipient station containing a link to a web page for processing the temporarily-stored cryptographically-encoded email.

Preferably, but not necessarily, a cryptographically-encoded email is generated by the sender or on his behalf, possibly using technologies that practice the teachings of the previously-mentioned PCT International Publication Number WO 2005/078993, PCT International Publication Number WO 2007/071040 and PCT International Publication Number WO 2007/071041, and sent to a multitude of recipients or a single recipient. By sending the recipient the entirety or the most important part of the cryptographically-encoded email directly, the scalability issue is partly addressed since the need for a staging server is eliminated or, at the very least, greatly diminished.

Preferably, but not necessarily, upon receiving the cryptographically-encoded email, the recipient, who is assumed to have no specialized email client plugin to deal with said email, needs an ad-hoc processing mechanism for processing the email. As mentioned earlier, this ad-hoc processing mechanism should preferably be phishing-proof. In other words, while all efforts should be made to make it as simple as possible for a typical recipient to easily process an incoming cryptographically-encoded email, said email should avoid being delivered to a recipient in a form that can easily be abused by a malicious third party.

One such approach is to require that the recipient manually contact a processing module for providing it with the cryptographically-encoded email and interacting with said processing module for the proper processing of the cryptographically-encoded email. If such an approach is needed then the fashion in which the processing module is contacted would preferably, but not necessarily, be absent from the actual email. Rather, it would be communicated by the sender to his recipient or recipients through a different communication channel such as the phone or the fax. This, therefore, would force a malicious third party to establish credibility with a targeted recipient prior to attempting to lure said recipient by means of a phishing attack. Hence, a recipient would have an additional opportunity to unmask an attacker.

While such an approach would impose an additional step for the deployment of this method within legitimate communications, appropriate information campaigns, communication tools and human relations material and procedures may be put in place to alleviate the underlying burden caused by such procedures. For example, in the case of a law office, an attorney sending an email to a recipient which must use an embodiment of the present disclosure to process the email sent to him by said attorney could request that his assistant contact the recipient in person over the phone to explain the procedure to him beforehand. Such communication would, if needed, ensure that the trust in between the different parties is maintained and would be difficult, though not impossible, to be abused by a malicious third party.

Embodiments of the present disclosure are typically, but not necessarily, composed of a cryptographically-encoded email received by a recipient or on his behalf, a processing module for processing said cryptographically-encoded email, a processing request sent by the recipient to the processing module, and the recipient and processing module interaction by which a recipient is able to properly process the cryptographically-encoded email.

Typically, but not necessarily, the recipient transmits the cryptographically-encoded email to the processing module and triggers a processing request with said processing module, or vice-versa, both orders of events being covered by embodiments of the present disclosure including the case where the transmission of both the cryptographically-encoded email and the processing request occur simultaneously. The processing module, in turn, enables the recipient to interact with it in order to process the cryptographically-encoded email.

Other features of the presently disclosed system and method for ad-hoc processing of cryptographically-encoded data will become apparent from the following detailed description taken in conjunction with the accompanying drawings, which illustrate, by way of example, the presently disclosed system and method.

### BRIEF DESCRIPTION OF THE DRAWINGS

A detailed description of preferred embodiments will be given herein below with reference to the following drawings, in which like numbers refer to like elements:

FIG. 1 is a simplified block diagram illustrating a system for ad-hoc processing of cryptographically-encoded data according to the present disclosure.

FIG. 2 is another simplified block diagram illustrating a system for ad-hoc processing of cryptographically-encoded data according to the present disclosure wherein a pre-processing module is connected to the sender unit for pre-processing an email before it is sent to the recipient.

FIG. 3 is another simplified block diagram illustrating a system for ad-hoc processing of cryptographically-encoded data according to the present disclosure wherein a pre-processing module is connected to the sender unit for pre-processing an email during its transit to the recipient.

FIG. 4 is a block diagram illustrating an embodiment of a system for ad-hoc processing of cryptographically-encoded data wherein the processing module is integrated in a processing server.

FIG. 5 is a block diagram illustrating another embodiment of a system for ad-hoc processing of cryptographically-encoded data wherein the processing module is integrated in a processing server and wherein the pre-processing module used by the sender station prior to the email's transmission to the recipient is integrated in a pre-processing server.

FIG. 6 is a block diagram illustrating another embodiment of a system for ad-hoc processing of cryptographically-encoded data wherein the processing module and the pre-processing module used by the sender station prior to the email's transmission to the recipient are integrated in a unified processing server.

FIG. 7 is a block diagram illustrating another embodiment of a system for ad-hoc processing of cryptographically-encoded data wherein the processing module and the pre-processing module that pre-processes an email after it is sent to the recipient are integrated in a gateway processing server.

FIG. 8 is a block diagram illustrating another embodiment of a system for ad-hoc processing of cryptographically-encoded data wherein the gateway processing server is located before the sender's mail server.

FIG. 9 is a block diagram illustrating another embodiment of a system for ad-hoc processing of cryptographically-encoded data wherein the sender's email transits through a bypass processing server instead of the sender's usual mail server.

FIG. 10 is a block diagram illustrating another embodiment of a system for ad-hoc processing of cryptographically-encoded data wherein the gateway processing server is located before the recipient's mail server.

FIG. 11 is a block diagram illustrating another embodiment of a system for ad-hoc processing of cryptographically-encoded data wherein the pre-processing module is integrated in the recipient's mail server.

FIG. 12 is a block diagram illustrating the internal architecture of the Kryptiva™ components commercialized by Kryptiva inc. which implement an embodiment of a system for ad-hoc processing of cryptographically-encoded data according to the present disclosure wherein the recipient provides the cryptographically-encoded email to the Kryptiva Packaging Gateway by way of copy-and-pasting.

FIG. 13 is a block diagram illustrating the internal architecture of the Kryptiva™ components which implement an embodiment of a system for ad-hoc processing of cryptographically-encoded data according to the present disclosure wherein the recipient provides the cryptographically-encoded email to the Kryptiva Packaging Gateway by way of forwarding said email.

FIG. 14 is a block diagram illustrating the architecture of the Kryptiva™ components which implement an embodiment of a system for ad-hoc processing of cryptographically-encoded data according to the present disclosure wherein pre-processing is implemented through communication between the Kryptiva Packaging Server and the Kryptiva Packaging Gateway.

FIG. 15 illustrates a high-level sequence diagram of the operations performed for processing a cryptographically-encoded email through copy-and-pasting its contents to a web page.

FIG. 16 illustrates a high-level sequence diagram of the operations performed for processing a cryptographically-encoded email through forwarding it to a server.

FIG. 17 illustrates the steps performed by the Kryptiva Packaging Gateway for processing a cryptographically-encoded email through the copy-and-paste method.

FIG. 18 illustrates the steps performed by the Kryptiva Packaging Gateway for processing a cryptographically-encoded email through the email forwarding method.

FIG. 19 illustrates a sample Kryptiva-encoded email.

FIG. 20 illustrates a sample email returned by the Kryptiva Boomerang Service part of the Kryptiva Packaging Gateway.

FIG. 21 illustrates the typical web page displayed to recipients who have clicked on the URL provided in the boomerang email returned by the Kryptiva Packaging Gateway.

FIG. 22 illustrates the typical web page displayed to recipients for viewing their decrypted email with its attachments.

FIG. 23 illustrates the typical web page made available to recipients for copying-and-pasting the content of Kryptiva-encoded emails for processing by the Kryptiva Packaging Gateway.

FIG. 24 illustrates a high-level flowchart of the operations performed by a sender's gateway processing server as part of its pre-processing.

FIG. 25 illustrates a high-level flowchart of the steps performed by the recipient to view his cryptographically-encoded email using the gateway processing server.

FIG. 26 illustrates a high-level flowchart of the operations performed by a gateway processing server to identify and process incoming Kryptiva-encoded emails that may have been forwarded by recipients.

### DETAILED DESCRIPTION OF THE PREFERRED EMBODIMENTS

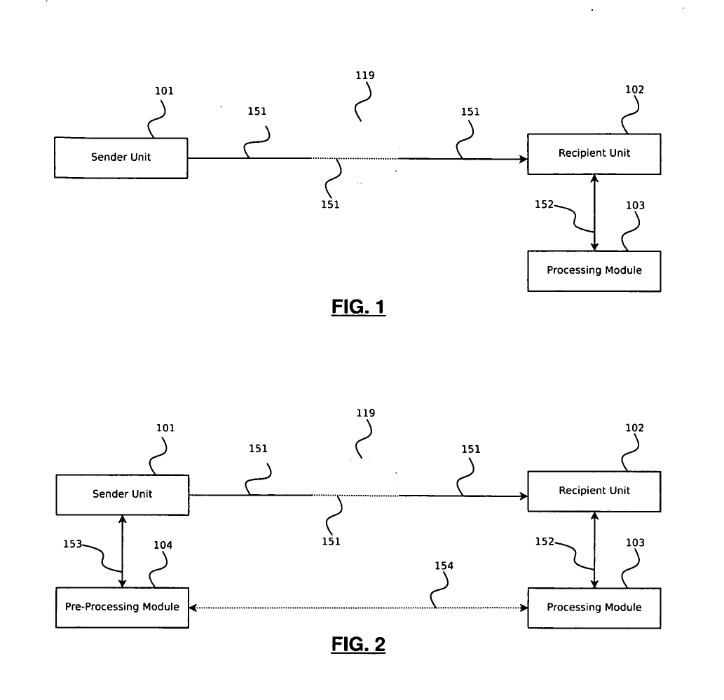

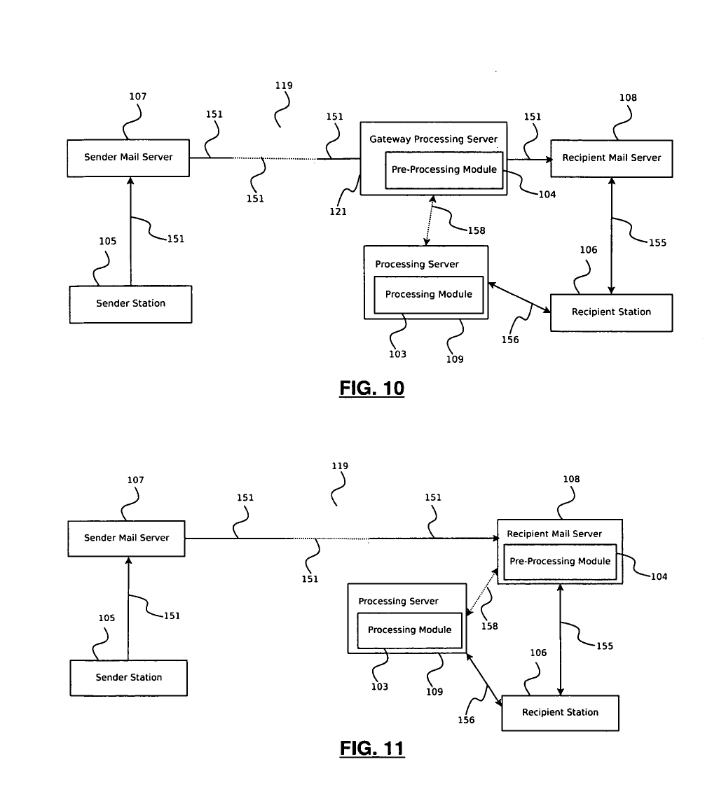

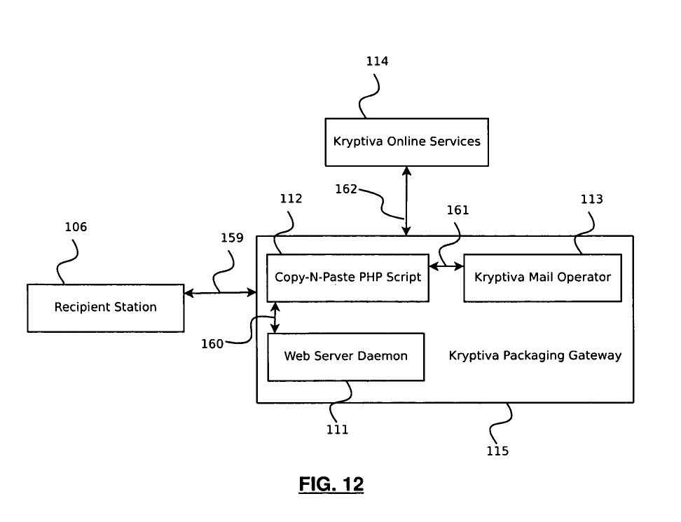

FIG. 1 to 3 illustrate the system for ad-hoc processing of cryptographically-encoded data of the present disclosure. FIGS. 4 to 11 illustrate possible embodiments of the present disclosure and FIGS. 12 to 14 illustrate the embodiment of the present disclosure by the Kryptiva™ components. FIGS. 15 to 18 and 24 to 26 illustrate possible embodiments of an ad-hoc processing method according to the present disclosure. FIGS. 19 to 23 illustrate user content generated by Kryptiva™ components implementing an ad-hoc processing system and method according to the present disclosure. Some components presented may be replaced and other may be added without departing from the teachings of the present disclosure. Where used, dotted arrows indicate a set of possibilities. Details regarding Kryptiva™ components illustrated in some figures may be found in co-pending PCT International Publication Number WO 2005/078993, PCT International Publication Number WO 2007/071040 and PCT International Publication Number WO 2007/071041. The following will therefore cover the operation of only those components which are not already described in said publications.

The following discussion is based on three (3) main recipient interfaces. It will be obvious to a person ordinarily skilled in the art that other recipient interfaces may easily be devised based on the teachings of the present disclosure.

Recipient Interfaces

In order to enable a recipient to process cryptographically-encoded data in an ad-hoc fashion, the recipient must be provided with an method for interacting with the ad-hoc processing system. Each method, which will be referred to as an “interface”, allows the recipient to interact with embodiments of the system in a different fashion. Separate interfaces may be applicable in different circumstances and interfaces may be combined to provide the required user experience.

As a first interface, the recipient may be provided with a web URL for the processing module 103 which, upon being visited, provides the recipient with a form where he can copy and paste the content of the received cryptographically-encoded email and a button which he can then press to initiate the processing of the email.

As a second interface, the recipient may be provided with a web URL for the processing module 103 which, upon being visited, provides the recipient with a form that allows the recipient to upload a file containing the received cryptographically-encoded email and a button which he can then press to initiate the processing of the email. The file containing the email could be generated through the “Save mail as . . . ” feature of the user's existing email client software.

As a third interface, the recipient may forward the cryptographically-encoded email to the processing module 103 by way of using his existing email client interface and designate as the recipient of the forward an email address associated with the processing module 103 and provided by the sender. The processing module 103, having received the cryptographically-encoded email, could then conduct verifications on said email, such as checking the email's signature, store the email for further processing and then reply back or send a new email to the recipient containing a URL to a web page where the recipient will be able to interact with the processing module 103 in order to properly process the cryptographically-encoded email. Having received that second email, the recipient can click on or otherwise open the URL and proceed to interact with the processing module 103. If the cryptographically-encoded email were encrypted, for example, such interaction may result in the recipient being prompted for providing an authorization token, such as a password, before being allowed to view the decrypted content by the processing module 103.

While embodiments implementing each of these interfaces is further discussed in more detail below, embodiments of the present disclosure based on other interfaces are also possible. Recipients may, for example, use an FTP site to upload files containing cryptographically-encoded emails. The following detailed description of the basic components common to most embodiments further illustrates the range of possible embodiments.

Basic Components

Emails are typically sent from a sender unit 101 to a recipient unit 102 (arrow 151), possibly using a network 119. Typically, the sender unit 101 is any system, device, workstation, server, appliance, computing platform, or hardware capable of transmitting email, regardless of whether it has an active user directly interacting with it at any point in time. One embodiment of the sender unit 101, a sender station 106, is a typical computer system including hardware such as a CPU, or set of tightly-coupled CPUs, RAM, flash, buses, bus controller or controllers, network interface, peripherals and other hardware components, and configured for running software such as an operating system and applications. The sender station 106 may be a fixed computer devices such as a PC workstation running a popular operating system, such as Windows®, MacOS®, or Linux®, or it may be a portable device such as a Blackberry®, Palm® Treo™, or a generic device running an embedded operating system, such as Symbian® or Windows® Mobile™, or it may be a server system, or a set of aggregated servers, running a server operating system, such as Windows® Server or Red Hat® Linux®, or it may be any such similar system.

Similarly to the sender unit 101, the recipient unit 102 may be any system, device, workstation, server, appliance, computing platform, or hardware capable of receiving email and preferably, but not necessarily, of browsing the web, regardless of whether it has an active user directly interacting with it at any point in time. One embodiment of the recipient unit 102 is a recipient station 106 having similar characteristics as the sender station 106.

Emails are typically sent from the sender station 106 first to the sender mail server 107. The sender mail server 107 then transmits the email to the recipient mail server 108. The email is then retrieved from the recipient mail server 108 by the recipient station 106 for presenting to the recipient.

The cryptographically-encoded email is typically, but not necessarily, an email containing cryptographic information within one of its email parts, such as, but not limited to, the body, attachments or headers. The cryptographic information could be specified in binary form or be encoded with an encoding such as base64 to allow its transport within a text-based email protocol. The cryptographic information could be embedded within existing email parts, such as before or after text typed-in by the sender in the plaintext or HTML body parts, or could be included as a new email part such as a plaintext or binary attachment. The cryptographic information could also be specified as a multitude of parts that replace some or all of the existing email parts. Alternatively, the cryptographic information could be a simple resource locator included in an email header or other email part, such as a web URL, that indicates where additional cryptographic data pertaining to the email may be located. Cryptographic information may also be encoded in a variety of other ways without departing from the teachings of the present disclosure.

The processing module 103 is typically, but not necessarily, a service running on a server that receives the cryptographically-encoded email and processing requests from recipients, processes those requests and their associated cryptographically-encoded email, and interacts with said recipients to allow them to properly process the cryptographic information included in the cryptographically-encoded email. The processing module 103 may attempt to verify the recipient's identity before processing the cryptographically-encoded email, for instance by requesting and validating the recipient's credentials. The processing module 103 may also prompt the recipient for information required to process the cryptographically-encoded email, such as, for example, the password allowing the decryption of the email in the case where the cryptographically-encoded email contains encrypted content. In general, the processing module 103 may conduct a number of operations on a received cryptographically-encoded email prior to interacting with the recipient. Such operations may include decoding, re-encoding, preprocessing, signature verification, decryption, encryption, and other cryptography-related or data-processing-related operations. For example, the processing module 103 may allow partial processing of the cryptographically-encoded email before requiring the recipient to further interact with it in order to complete the cryptographically-encoded email's processing

The processing module 103 may itself be composed of additional submodules or it may be aggregated along with other modules to form module aggregates. The processing module 103 could be implemented as a single dedicated server, the processing server 109, or be integrated within an existing, common server. Alternatively, the processing module 103 could be implemented as a set of separate servers. The processing module 103 may be hosted entirely or partially by a TTP, or by a sender's organization, for example within its DMZ. Distributing the processing module 103 over both a TTP and a client organization would enable the TTP to perform the less sensitive parts of the cryptographic operations required to fully process the cryptographically-encoded email and let the client organization handle the more sensitive operations, such as decrypting the content of the cryptographically-encoded email. The processing module 103 could also be implemented as a mobile hardware device, such as a USB dongle that the recipient connects to his computer as needed. Other configurations are also possible.

The processing module 103 may be made accessible to the recipient by supplying him with a URL or IP address to a web server that provides forms allowing for the processing of the cryptographically-encoded email. The forms could present the visitor with an interface for copy-and-pasting the content of the email and/or an interface for uploading a file containing the cryptographically-encoded email. Those forms could also require the visitor to fill-in additional fields that let him specify his credentials or enter other information required to process the cryptographically-encoded email. Such fields to fill-in may also be presented to the visitor after the cryptographically-encoded email processing has been initiated. Typically, but not necessarily, when the visitor generates a processing request by clicking on the “OK” button after having uploaded or copy-and-pasted the cryptographically-encoded email to the form, a server-side or client-side application, procedure or script is invoked to process the cryptographically-encoded email. Having received the cryptographically-encoded email and a processing request, the processing module 103 may initiate some form of cryptographically-encoded email processing. Thereafter, the script interacts with the visitor in order to present the processed content to the viewer. Such interaction may require the visitor to further provide additional information, like passwords and other credentials.

The processing module 103 could also be made accessible to the recipient by supplying him with an email address serviced by a mail server that may be connected, packaged, hosted along or otherwise associated with the processing module 103. In this implementation, the recipient forwards the cryptographically-encoded email to the email address that was provided to him. Upon receiving the forwarded email, the processing module 103 typically, but not necessarily, extracts the cryptographically-encoded email from the forwarded email and possibly stores it locally and/or performs some form of basic cryptographically-encoded email processing, such as validating the cryptographically-encoded email's signature if it were signed. The processing module 103 could thereafter send a new email to the recipient containing a web URL to a web site having forms similar to those described above to allow the recipient to interact with the processing module 103 in order to access the processed content of the cryptographically-encoded email. Another possibility is that the recipient is provided with this web URL along with an email address, the recipient then must know that he must visit the given URL after having forwarded the cryptographically-encoded email since the processing module 103 would then be configured not to send an email in return for having received a cryptographically-encoded email, as described earlier. Yet another possibility is that the processing module 103 could return the processed content of the cryptographically-encoded email to the recipient via regular email sent over a secured communication link, TLS for example. A further possibility is that the processing module 103 return the processed content of the cryptographically-encoded email in the form of a password-encrypted ZIP file. Other means for accessing the processing module 103 than by way of a URL, IP address or email address are also possible without departing from the teachings of the present disclosure.

Cryptographically-encoded email processing by the processing module 103, which may be conducted iteratively as part of the processing module's 103 interaction with the cryptographically-encoded email's recipient, may involve a number of different steps. Such processing may, for instance, involve cryptography-related operations, such as decryption and signature verification, or data-processing operations, such as string manipulations and format conversions, or an iterative combination of such said operations. Typically, though not necessarily, the purpose and actual end result of such operations is to enable the recipient to be presented with information about the cryptographically-encoded email in a form that the sender intended. In the case where the sender transmitted encrypted information to the recipient as part of the cryptographically-encoded email, for example, such processing by the processing module 103 would likely enable the recipient to view the decrypted content of the cryptographically-encoded email as originally sent by the sender prior to being encoded cryptographically as part of an email. As part of its processing, the processing module 103 may need to communicate with external services in order to process the cryptographically-encoded email. For instance, to validate the origin of a cryptographically-signed email, the processing module 103 may need to contact a public key server or a certificate server to obtain the information required to verify the signature of the email. Typically, though not necessarily, the processing module's 103 processing is conducted by software implemented as web server scripts such as in programming languages like PHP, C with CGI, Perl or Python.

To reduce storage requirements, the processing module 103 could be configured to periodically purge the cryptographically-encoded emails it has received, typically after a fixed delay has elapsed. The processing module 103 could also automatically purge a cryptographically-encoded email after the recipient has finished viewing it in its processed form.

The processing request is typically, but not necessarily, an action made by the recipient to request that the processing module 103 process the cryptographically-encoded email. In the case where the recipient accesses the processing module 103 through a URL or an IP address, the processing request could be a click on an “OK” button on a form displayed to the recipient through a web browser; such would be the case for the forms described above which can be used by the recipient to copy-and-paste the content of the cryptographically-encoded email or upload the file containing of the cryptographically-encoded email. In the case where the recipient initiates communication with the processing module 103 by forwarding the cryptographically-encoded email to an email address associated with the processing module 103, the processing request is that very action of forwarding the cryptographically-encoded email. In itself, the forwarding may be done in a number of different ways. The content being forwarded may, for example, be included inline as part of the forwarded email or it may be sent as an attachment of the forwarded email. Another possibility is that the processing request is in fact a reply message sent by the cryptographically-encoded email's recipient back to the sender and containing the actual cryptographically-encoded email, said reply being intercepted on its way to delivery by a special filter on a mail server. Yet another possibility for triggering a processing request is an HTTP or network request issued by the recipient, either manually or automatically on his behalf. For instance, the recipient could configure the mail filter on his local machine to automatically request processing of a cryptographically-encoded email upon its reception. As described at the following URLs for example, http://office.microsoft.com/en-us/outlook/HA010347681033.aspx and http://office.microsoft.com/en-us/outlook/HA011502011033.aspx, one can configure Microsoft Outlook to automatically scan for certain content and thereafter forward the incoming email to a given address; the same of course can be done with other email client applications. Such a mechanism could easily be used to automatically trigger the processing of an incoming cryptographically-encoded email, again without requiring the recipient to add any software on his system. Similar functionality could also be obtained by appropriately configuring mail servers on the recipient's side to automatically trigger the processing request on the recipient's behalf.

The recipient and processing module 103 interaction is typically, but not necessarily, characterized by some form of exchange between the recipient and the processing module 103 after the former has issued the processing request to the latter. Such interaction may be conducted by way of a web interface, an email exchange, some form of automated or manual network communications or a combination thereof. Said interaction may involve the recipient being prompted for additional information in order to permit the processing module 103 to further process the cryptographically-encoded email. For instance, the processing module 103 may provide the recipient with a web form to enter a password required to decrypt the content of the cryptographically-encoded email. Having provided such information, the recipient may submit the required information and be further required to interact with the processing module 103 in order to yet further process the cryptographically-encoded email. Also, the processing module 103 may, during the process of interacting with the recipient communicate with other modules, servers or even individuals. The interaction between the recipient and the processing module 103 may involve many steps and may branch off in a number of directions. Typically, though not necessarily, the result of such interaction is that the recipient is presented with data in a form fitting the cryptographically-encoded email sender's requirements. For example, if the sender sent an encrypted email to the recipient, the recipient and processing module 103 interaction would typically allow the recipient to view the email in its unencrypted form. In the case where interaction between the recipient and the processing module 103 involves email exchanges, two-factor authentication may be used to allow the recipient to validate the origin of the emails he receives from the processing module 103.

In the case where the cryptographically-encoded email included encrypted material sent by the sender, the recipient and processing module 103 interaction would result in the content the sender has typed-in prior to sending the cryptographically-encoded email being typically displayed to the recipient through a web browser, either in plaintext format or rendered as an HTML page. In such an embodiment, attachments sent by the sender would typically be made available to the recipient through links to files containing the attachment data. Various other possibilities exist, such as allowing the recipient to download a compressed file containing the processed content or transferring said compressed file to the recipient by including it as an attachment of an email sent to the recipient over a secured communication link. Also, the recipient may receive the sender's content, either by email or through a web form, as a ZIP file encrypted with a password set as being the same as the one set by the sender as part of generating the cryptographically-encoded email. If the recipient is presented with the decrypted content through a web interface, he may also be given the option to reply securely to the sender, possibly through secure web interface.

### First Set of Embodiments

The first set of embodiments is exemplified by FIG. 1. In this set of embodiments, a cryptographically-encoded email is sent from the sender unit 101 to the recipient unit 102 (arrow 151) and the recipient unit 102 interacts with the processing module 103 (arrow 152) to make the decrypted email accessible to the recipient. FIG. 4 illustrates a typical network where the sender station 106 sends a cryptographically-encoded email to the recipient station 106 through the sender mail server 107 and the recipient mail server 108. Having retrieved the cryptographically-encoded email from the recipient mail server 108 (arrow 155), the recipient station 106 would interact with the processing server 109 (arrow 156) to make the decrypted email visible to the recipient.

In FIG. 15 there is illustrated a sequence diagram showing the communication between the recipient unit 102 and the processing module 103 when a web interface is provided for the recipient to copy-and-paste the content of the cryptographically-encoded email through a web page for processing by the processing module 103. In 201, the recipient launches his browser and visits the website of the processing module 103 using the URL or IP address that was provided to him. In 202, the processing module 103 sends a HTML form enabling the recipient to submit the cryptographically-encoded email content and any required additional information. In 203, the recipient copies-and-pastes the content of the cryptographically-encoded email into the HTML form and provides other information as needed. In 204, the recipient clicks on the “OK” button, thereby triggering the processing request. In 205, the processing module 103 initiates the processing of the cryptographically-encoded email. In 206, if needed, the processing module 103 prompts for the recipient for any required additional information, typically by sending him additional HTML forms. In 207, if needed, the recipient provides the requested information by filling out the forms and submits the forms to the processing module 103, typically by clicking on an “OK” button. In 208, the processing module 103 completes the processing of the cryptographically-encoded email. In 209, the processing module 103 sends an HTML page to the recipient describing the result of the processing. In the case where the cryptographically-encoded email is an encrypted email, the message typed-in by the sender of the cryptographically-encoded email is typically displayed in that page.

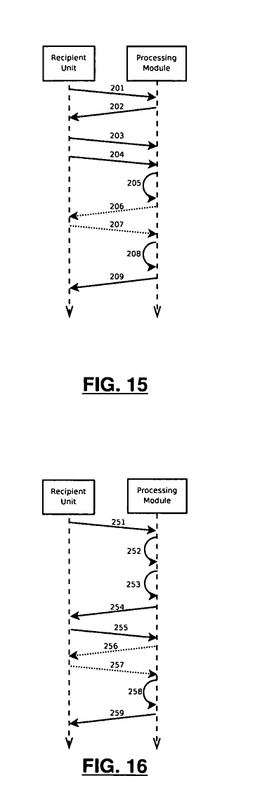

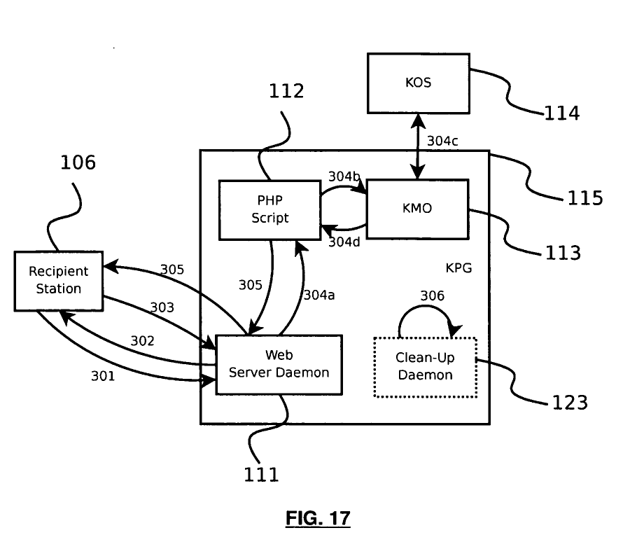

In FIG. 16 there is illustrated a sequence diagram showing the communication between the recipient and the processing module 103 when the cryptographically-encoded email is submitted for processing to the processing module 103 by the recipient by way of email forwarding. In 251, the recipient forwards the cryptographically-encoded email to the email address associated with the processing module 103 that was provided to him, thereby triggering the processing request. In 252, the processing module 103 receives the email containing the cryptographically-encoded email and extracts the cryptographically-encoded email from it. In 253, the processing module 103 initiates the processing of the cryptographically-encoded email. Note that steps 252 and 253 may also be conducted after the following step 255. In 254, the processing module 103 sends an email containing a web URL to the recipient to enable him to interact with it for processing the cryptographically-encoded email. In 255, the recipient receives the email that was sent to him by the processing module 103 and clicks on the URL contained within, thereby typically, but not necessarily, starting his web browser and contacting the processing module's 103 web server. In 256, if needed, the processing module 103 prompts the recipient for any required additional information typically by sending his browser an HTML form. In 257, if needed, the recipient fills in the requested information into the form and submits the form to the processing module 103, typically by clicking on an “OK” button. In 258, the processing module 103 completes the processing of the cryptographically-encoded email. In 259, the processing module 103 sends an HTML page to the recipient describing the result of the processing. In the case where the cryptographically-encoded email is an encrypted email, the message typed-in by the sender of the cryptographically-encoded email is typically displayed in that page.

### First Set of Embodiments as Implemented by Kryptiva™ Components

In FIG. 12 there is illustrated a block diagram of the Kryptiva Online Kryptiva Mail Operator 113 Service which allows a recipient to use its services through a web URL for processing a Kryptiva-packaged email (typically an email that was created by a Kryptiva Packaging Server 118 as a result of a packaging request from a Kryptiva Mail Operator 113 on behalf of a Kryptiva Packaging Plugin as is illustrated in FIG. 19). This service may be a standalone offering from Kryptiva or it may be packaged as part an existing or future product such as the Kryptiva Packaging Gateway 115. The Kryptiva Online Kryptiva Mail Operator 113 Service is thus typically, though not necessarily, composed of a copy-and-paste PHP script 112, or a set of such scripts, accessible via a web URL serviced by a web server daemon 111, the Kryptiva Mail Operator 113 and local storage on the server. The sequence diagram corresponding to the interactions between the modules illustrated in FIG. 12 is illustrated in FIG. 17.

In 301, the recipient launches his browser and visits the Kryptiva Packaging Gateway 115 using the URL or IP address that was provided to him.

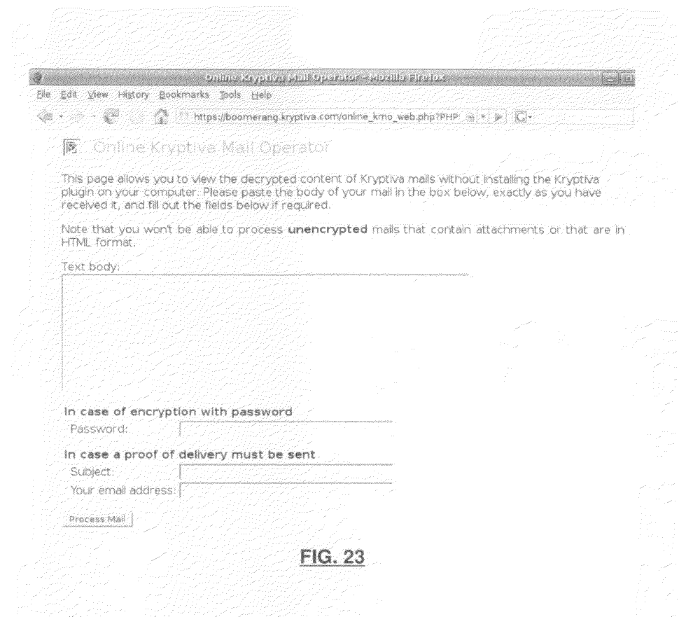

In 302, the Kryptiva Packaging Gateway 115 sends an HTML form where the recipient can either copy-and-paste the body of a Kryptiva email or upload a file containing a Kryptiva email, the form for copy-and-paste being illustrated in FIG. 23. The form also contains a field where the recipient can enter a decryption password, should the Kryptiva email be encrypted with a password. Furthermore, to cater for Kryptiva emails formatted for Proof-of-Delivery (PoD), the form contains a field asking for the email address of the person reading the mail. This field enables the Kryptiva Packaging Gateway 115 to properly notify the sender of the email that the given recipient has received the email.

In 303, the recipient fills in the fields of the form and clicks on the “OK” button, thereby submitting the form for processing by the server-side scripts.

In 304a, the copy-and-paste PHP script 112 on the Kryptiva Packaging Gateway 115 is invoked by the web server daemon 111 to process the information supplied by the user. In 304b, the copy-and-paste PHP script 112 extracts the Kryptiva payload from the body of the email and sends it to the Kryptiva Mail Operator 113 along with the decryption password and the email address of the recipient if they were provided. In 304c, the Kryptiva Mail Operator 113 then verifies the signature of the email by obtaining the required public key data from the Kryptiva Online Services 114. If the email is encrypted with a password, the Kryptiva Mail Operator 113 contacts the Kryptiva Online Services 114 to decrypt the content using the password supplied by the recipient. If the email is formatted for PoD, the Kryptiva Mail Operator 113 contacts the Kryptiva Online Services 114 to decrypt the content of the email, passing along the purported email address of the recipient. Note that the password and PoD information may also be requested at a later step. In 304d, the Kryptiva Mail Operator 113 then returns the processed content back to the copy-and-paste PHP script 112.

In 305, using the Kryptiva Mail Operator's 113 output, the copy-and-paste PHP script 112 outputs an HTML page containing the text of the email typed-in by the sender of the email. If there were attachments, the page displays links enabling the recipient to download them. The recipient then has access through his web browser to the processed content sent to him by the sender.

In 306, the clean-up daemon 123 on the Kryptiva Packaging Gateway 115 deletes the information pertaining to the email of the recipient after a suitable delay has elapsed to reclaim the storage space.

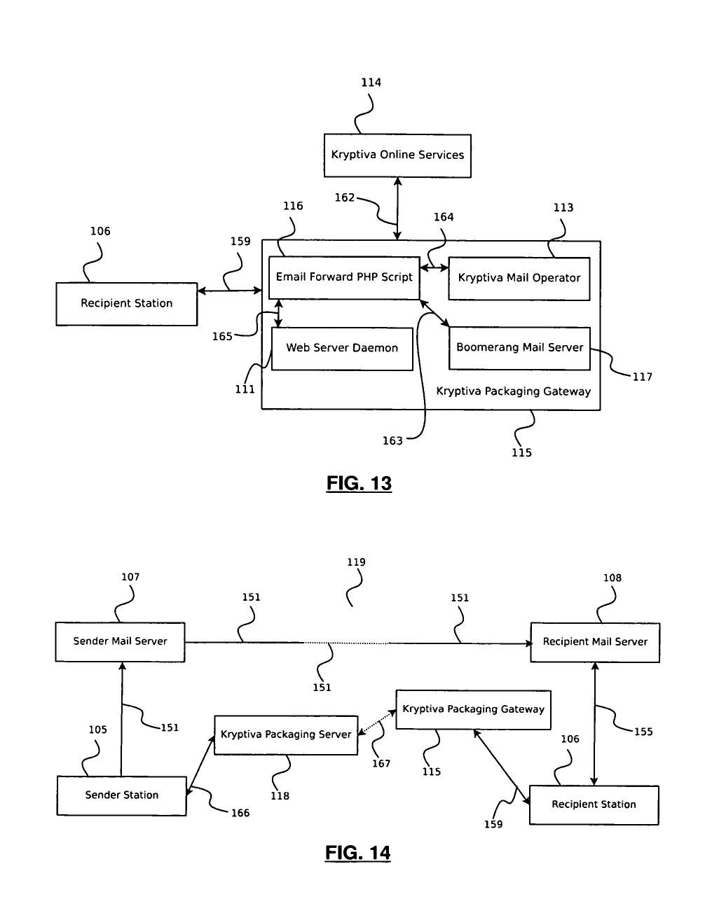

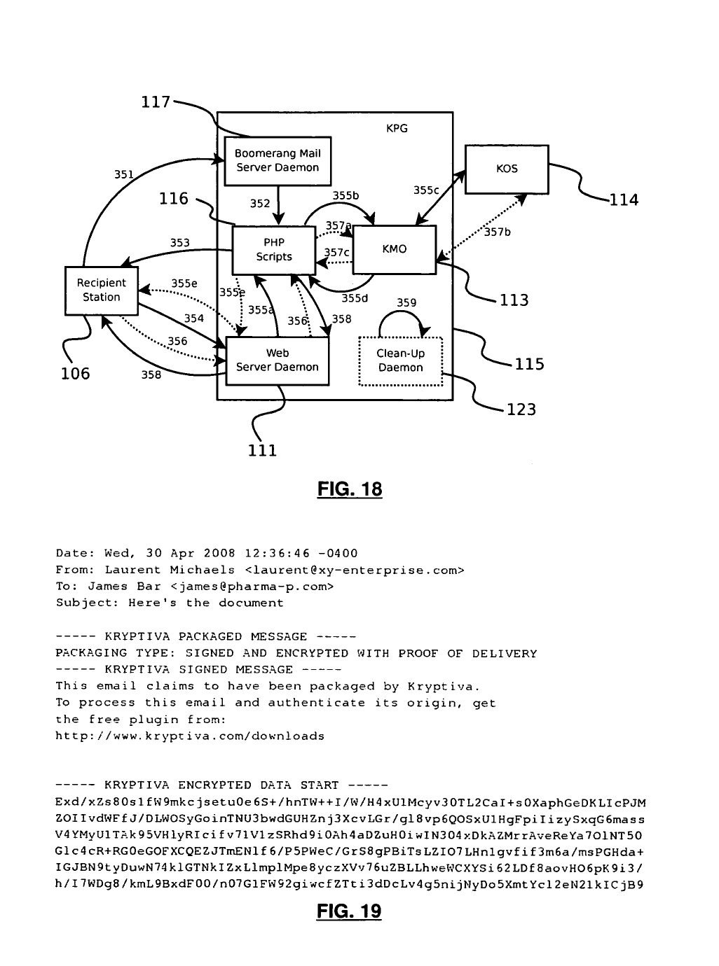

In FIG. 13 there is illustrated a block diagram of the Kryptiva Boomerang Service which allows a recipient to use its services by forwarding it a Kryptiva-packaged email for processing. This service may be a standalone offering from Kryptiva or it may be packaged as part an existing or future product such as the Kryptiva Packaging Gateway 115. The Kryptiva Boomerang Service is thus typically, though not necessarily, composed of a Mail Server Daemon, Postfix for instance, the email forward PHP script 116 that may possibly triggered by an incoming email and also accessible via a web URL serviced by a web server daemon 111, the Kryptiva Mail Operator 113 and local storage on the server. The use of the term “Boomerang” is related to the fact that the process provided to the recipient for processing Kryptiva-packaged emails mimics that of a real-life boomerang in that the recipient sends something and gets something else in return. As such, the following references to “Boomerang” imply mention of that metaphor. Such is the case when discussing the “Boomerang method”. The sequence diagram corresponding to the interactions between the modules illustrated in FIG. 13 is illustrated in FIG. 18.

In 351, the recipient forwards the Kryptiva-packaged email to the email address that was provided to him, for example boomerang@kryptiva.com. Note that the exact address to use by the recipient could be specific to the sender's organization, such as boomerang@xy-enterprise.com, or a generic address may be used by all recipients, say boomerang@kryptiva.com, and email incoming at that address could then be automatically dispatched to a processing server (a Kryptiva Packaging Gateway 115) hosted by the sender's organization. Note also that the email forwarded by the recipient may not reach the boomerang mail server 117 part of the Kryptiva Packaging Gateway 115 directly. Instead, it may travel across a wide number of separate and independent mail servers before reaching the actual server hosting the Kryptiva Packaging Gateway 115 and, therefore, the boomerang mail server 117 running on said Kryptiva Packaging Gateway 115.

In 352, the forwarded email is received by the Kryptiva Packaging Gateway 115 boomerang mail server 117. The boomerang mail server 117 is configured so that emails sent to a designated Boomerang address, say boomerang@kryptiva.com, are handed off automatically to a PHP script that first extracts the Kryptiva payload from the forwarded email. Since different email clients have different ways of forwarding messages, the PHP script may need to repair the damage done to the Kryptiva payload in the forwarding process, such as removing the characters used to quote the Kryptiva payload. The PHP script also extracts the reply address included in the email used to forward the Kryptiva-packaged email, and stores it along with the extracted Kryptiva payload in a temporary directory on disk.

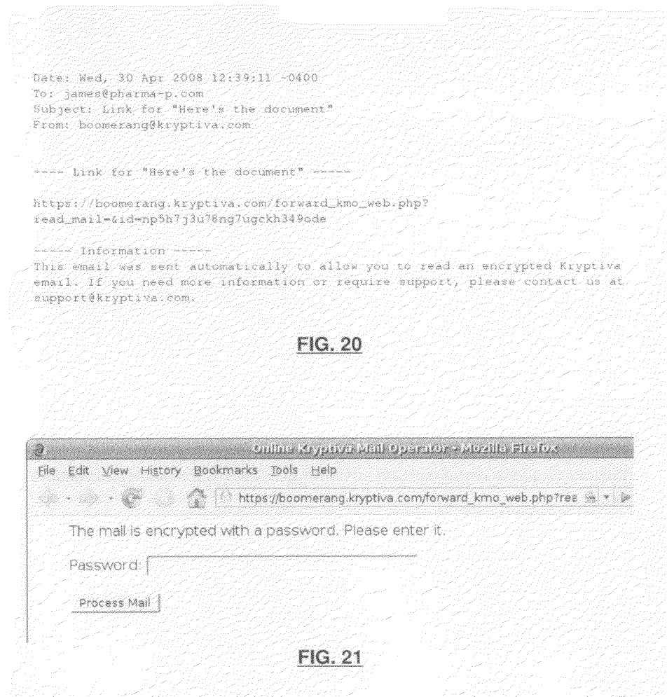

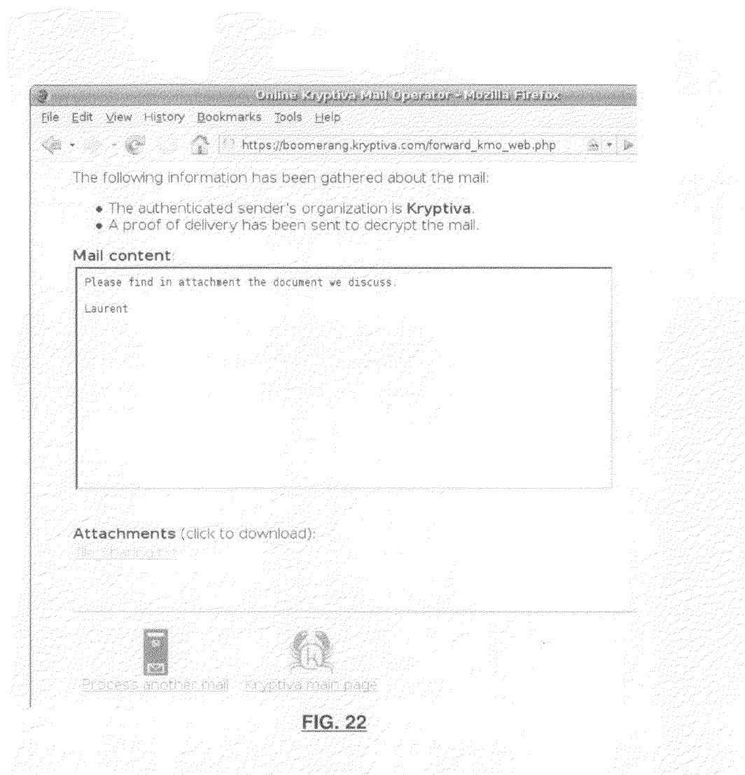

In 353, a PHP script, possibly the same as in 352 sends an email containing a web URL, said URL possibly pointing to a secure website (https:// . . . ) as illustrated in FIG. 20, to the recipient using the reply address included in the email used by the recipient to forward the Kryptiva-packaged email. The web URL is made to point to the Kryptiva Packaging Gateway 115 and includes a token identifying the temporary directory that contains the extracted Kryptiva payload. A number of measures may be used in order to avoid a malicious third party from abusing the described mechanism by causing the PHP script to send large amounts of URL-containing emails in an attack on a given email address or a set of email addresses. For example, the Kryptiva Packaging Gateway 115 may be made to throttle the number of processing requests depending on the request's originating IP address. A throttle may also be implemented by way of checking the Kryptiva Serial Numbers (KSNs) of the emails forwarded for processing and making sure that the number of processing requests for a given KSN does not exceed a certain threshold. Another measure would be to check that the “reply-to” address that was contained in the email that was used by the recipient to forward the Kryptiva-packaged email for processing was actually part of the recipient list of said Kryptiva-packaged email by verifying the list found in the Kryptiva Signature Packet (KSP). In addition, the email sent by the PHP script may be S/MIME-signed in order to allow the recipient to verify the origin of the email and also verify whether or not the email was tampered with along the way, hence making it extremely difficult for an attacker to mount a successful MITM attack.

In 354, the recipient receives the email containing the web URL and clicks on the web URL in the email, thereby launching his web browser and contacting the Kryptiva Packaging Gateway 115.

In 355a, a PHP script is invoked to process the extracted Kryptiva payload. The PHP script locates the temporary directory containing the extracted Kryptiva payload by using the token included in the web URL. In 355b, the PHP script then transmits the Kryptiva payload to the Kryptiva Mail Operator 113 in order to verify the signature of the email by way of interacting with the Kryptiva Online Services 114 (355c) and determine if the email was encrypted with a password. Based on Kryptiva Mail Operator's 113 output (355d), the PHP script typically, but not necessarily, sends an HTML form (355e) to the recipient's browser, prompting him to supply the decryption password as illustrated in FIG. 21.

In 356, if needed, the recipient provides the decryption password by filling the HTML form sent by the PHP script and submits it by clicking the “OK” button or otherwise causes the form to be sent for processing by a server-side script.

In 357a, if needed, having received additional information from the recipient, a PHP script requests the Kryptiva Mail Operator 113 to process the extracted Kryptiva payload. In 357b, if the email is encrypted with a password, the Kryptiva Mail Operator 113 contacts the Kryptiva Online Services 114 to decrypt the content using the password supplied by the user. If the email is formatted for PoD, the Kryptiva Mail Operator 113 contacts the Kryptiva Online Services 114 to decrypt the content of the email, passing along the reply address which was extracted from the email used by the recipient to forward the Kryptiva-packaged email. In 357c, the result of the Kryptiva Mail Operator's 113 processing is returned to the PHP script.

In 358, a PHP script outputs an HTML page containing the formatted output of the Kryptiva Mail Operator's 113 processing results, which would typically be the text of the email typed-in by the sender of the email as illustrated in FIG. 22. If there are attachments, for example, the page displays links enabling the recipient to download them. The recipient then has access through his web browser to the processed content sent to him by the sender.

In 359, the clean-up daemon 123 on the Kryptiva Packaging Gateway 115 deletes the information pertaining to the email of the recipient after a suitable delay has elapsed in order to reclaim the storage space. This thereby avoids the problems associated with emails being forwarded for processing but the recipient not following through with the processing of the email by clicking on the URL received. This is an additional advantage of this approach since the Kryptiva Packaging Gateway 115 can be made to be close to entirely stateless, contrary to most other approaches where stagging servers used to store emails for recipients in an ad-hoc fashion must actively maintain stored emails until they are retrieved by a recipient. The server could also clean up its storage at the recipient's explicit request.

With regards to phishing, embodiments of the present disclosure as implemented in Kryptiva's products are indeed less subject to that type of attack than other products on the market. The email packaged by the Kryptiva Packaging Server 118 includes, in fact, only a small notice explaining where to find additional information regarding the processing of the received Kryptiva-packaged email, though it may actually contain no notice at all. Either the recipient had been notified beforehand by the sender of how to process such email and the password to authorize access, or the recipient would then typically contact the sender (e.g. over the phone) as a result of receiving Kryptiva-packaged email in order to learn of the password required to view the message and, possibly, to get instructions on how to process such an email. In the case where the recipient copies-and-pastes the email body or uploads a file containing the email to a web page, there are no phishing possibilities since all steps are actively initiated by the recipient. The same goes for the case where the recipient forwards the email to the processing server (typically the Kryptiva Packaging Gateway 115) and receives an email containing a URL link since receiving an email with a URL requires the recipient to having first taken the initiative to forward content to the Kryptiva Packaging Gateway 115. In fact, the embodiments presented in this disclosure are typically less subject to phishing than other approaches since they require the recipient to actively solicit processing of an incoming email by a remote server while most phishing schemes rely on sending a large mass of unsolicited, malicious emails in the hopes that a few recipients will fall victim to cleverly-conceived bait. By requiring the recipient to actively solicit the processing of a remote server whose coordinates are typically not included in the cryptographically-encoded email received by the recipient, the embodiments discussed in the present disclosure therefore remove the active ingredients that make most phishing attacks work: the fact that they consist of unsolicited, self-contained and self-authenticating emails.

It could be argued that a new type of phishing attempts may be mounted once such a system is widely used, say by requesting in the first few lines of an incoming email that the email be forwarded to a given address in order to allow the recipient to access the real email that was sent to them. However, this would require an increased level of sophistication on the part of phishers since they would need to proceed in two steps before leading their victim to a fraudulent website and, by the same token, would require additional steps on the part of a potential victim before falling pray to the phishing scheme. So while it's not entirely impossible for a phisher to attempt to subvert the approaches described in the present disclosure, the potential for success is likely much lower than in the classic case where the phisher can simply send a familiar-looking email to an unsuspecting recipient which then only needs to click on the URL found in the email before being led to a familiar-looking website. It remains however that the ad-hoc processing approach described in the current disclosure is not a substitute for an effective email authentication mechanism, such as, for example, the one described in PCT International Publication Number WO 2005/078993. While it does allow recipients to process the occasional cryptographically-encoded emails they receive, it remains that it does not allow recipients to reliably authenticate senders. Ideally, therefore, this method should be used only temporarily until the recipient is able to install the Kryptiva Packaging Plugin in order to reliably process Kryptiva-packaged emails.

With regards to MITM attacks, the copy-and-paste method and the file upload method should be relatively immune to said attacks so long as the website to which the recipient is directed is secured, typically using SSL. In the case where the recipient forwards the email to the processing server (typically the Kryptiva Packaging Gateway 115) and receives an email containing a URL link, MITM attacks are still possible if the proper precautions are not taken, though such attacks remain relatively difficult to mount. Indeed, in order to attack the Boomerang approach, a malicious eavesdropper would need to detect the forwarding of the email to the processing server and send a forged email to the recipient containing a URL pointing to a maliciously-designed web site. To make the attack appear less suspicious and therefore more effective, the attacker would also need to prevent the email forwarded by the recipient from reaching the Kryptiva Packaging Gateway 115 or prevent the legitimate email containing the URL link generated by the Kryptiva Packaging Gateway 115 from reaching the recipient. To carry out such an attack effectively, however, the MITM would need to automatically detect that the recipient is forwarding an email to the Kryptiva Packaging Gateway 115 and have set up appropriate technical means for sending a forged email that would appear to be the genuine email containing the URL link requested by the recipient. Such tracking of the recipient's actions usually requires close proximity to the physical network connections used by the recipient or the Kryptiva Packaging Gateway 115, therefore limiting the applicability of this type of attack.

As mentioned earlier, such potential MITM attacks could be countered in a number of ways. As a first step, for example, the Kryptiva Packaging Gateway 115 could be made to check that the “reply-to” address of the email used by the recipient to forward the Kryptiva-packaged email is actually part of the recipient list of the Kryptiva-packaged email; though this is likely not sufficient for any well-mounted MITM attack. In addition, the URL provided in the email sent by the Kryptiva Packaging Gateway 115 may point to a secure web page (https:// . . . ) which has appropriate SSL certificates, therefore allowing the recipient to check that the browser properly displays the lock after having clicked on the URL. Yet another mechanism that could be used would be to require the recipient to import an S/MIME certificate corresponding to the Boomerang address which he could then use to encrypt his forward to the Kryptiva Packaging Gateway 115, making it impossible for an eavesdropper to modify the email before it reaches its destination. Also, as mentioned earlier, emails sent by the Kryptiva Packaging Gateway 115 could be S/MIME-signed in order to allow the recipient to verify their origin, which should be readily possible since S/MIME support is available in most email clients though typically not in webmail services such Yahoo! or Gmail.

The Preprocessing Module

In addition to the basic components discussed earlier, a pre-processing module 104 may be used to facilitate the ad-hoc processing of cryptographically-encoded data. The motivation being that while the previously-described functionality that is solely-based on a processing module 103 does indeed solve some of the problems associated with existing methods enabling a sender to share confidential information with recipients, there are circumstances where senders may want to have the best of both worlds. The pre-processing module 104 is therefore meant to decrease the number of recipient interactions required to read a cryptographically-encoded email, while still not suffering from problems such as scalability. Though, when used, the pre-processing module 104 may bring some of the same security issues that plague existing solutions, especially regarding the risks of phishing or MITM attacks. The use of the pre-processing module 104 is therefore a trade-off of functionality vs. security and, as such, would preferably, but not necessarily, an optional component of the present disclosure.

The pre-processing module 104 typically interacts with the processing module 103 in order to pre-process a cryptographically-encoded email. This pre-processing may be done either before the email is sent from the sender unit 101 to the recipient unit 102 or it may be done during the email's transit between the two. If it is done prior to transmission, then email transmitted may, for example, be made to already contain the URL the recipient will need to click in order to enter his credentials and get access to his email. If it is done during transit, then the pre-processing module 104 can act as a means for allowing recipients of the above-described staging server solutions to be able to read cryptographically-encoded emails that may have been garbage-collected by the staging server by forwarding said emails back to the staging server for processing by the processing module 103.

### Second Set of Embodiments

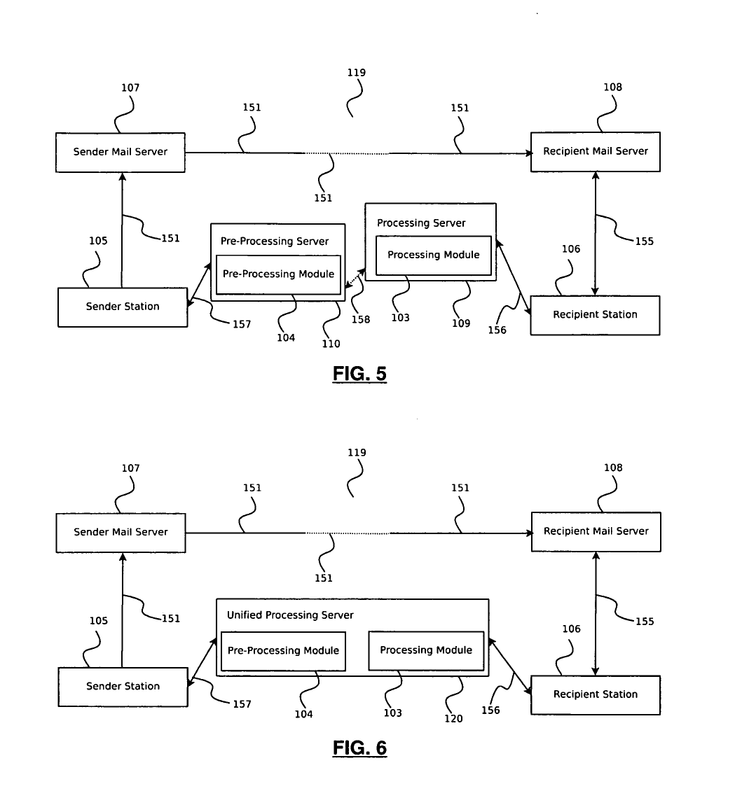

The second set of embodiments is exemplified by FIG. 2. In this set of embodiments, a cryptographically-encoded email sent from the sender unit 101 to the recipient unit 102 (arrow 151) may have been pre-processed by the pre-processing module 104 (arrow 153) while the recipient unit 102 interacts with the processing module 103 (arrow 152) in a similar fashion as in the first set of embodiments to the exception that there may be interaction between the processing module 103 and the pre-processing module 104 (arrow 154.) As is illustrated in FIG. 5, the sender station 106 would interact with the pre-processing server 110 (arrow 157) to pre-process the cryptographically-encoded email before it is sent to the recipient station 106 via the sender mail server 107. The recipient station 106 would then interact with the processing server 109 (arrow 156) to process the cryptographically-encoded email and the processing server 109 and pre-processing server 110 may interact (arrow 158.) FIG. 6 illustrates a system similar to that illustrated in FIG. 5 except that the processing module 103 and pre-processing module 104 are combined together into a unified processing server 120.

The advantage of using such configurations are especially interesting when applied to Kryptiva™'s components as is illustrated in FIG. 14. Using this configuration, it is indeed possible to implement secure message storing in a similar fashion to that performed by staging servers yet without having to trap the email after it leaves the sender station 106. There is, therefore, no modification to the existing network infrastructure. In fact, all emails would continue transiting using existing routes thereby eliminating any potential that Kryptiva™ components may add additional points of failure while still having cryptographically-encoded emails pre-stored for recipients on the Kryptiva Packaging Gateway 115. And, as mentioned earlier, emails could still be garbage-collected on the Kryptiva Packaging Gateway 115 while still recipients would be able to access their contents simply by forwarding the cryptographically-encoded email to the Kryptiva Packaging Gateway 115 once again.

### Third Set of Embodiments

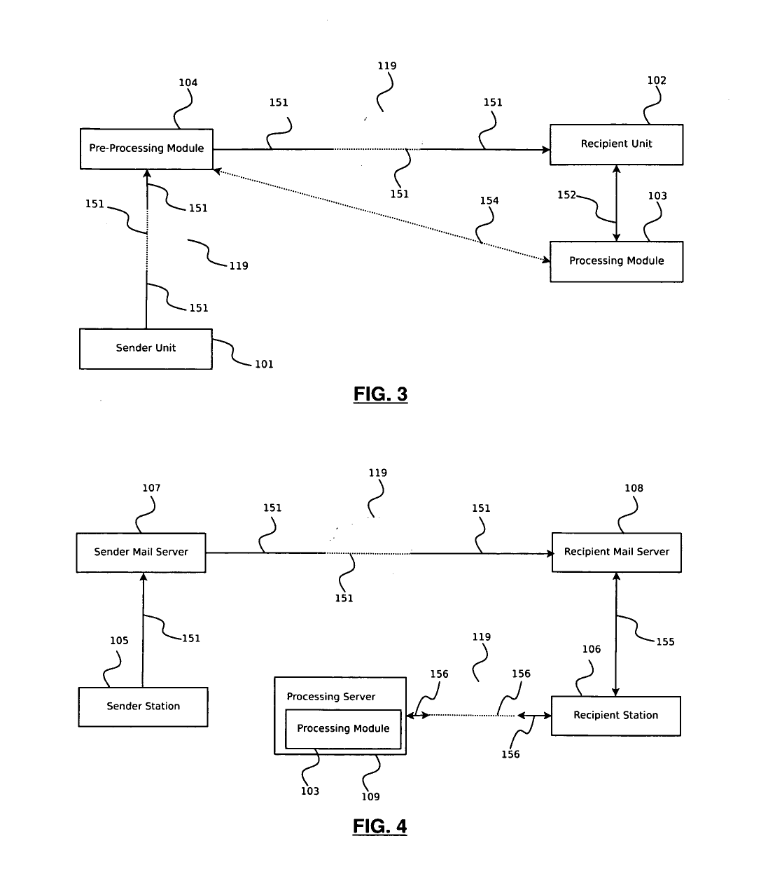

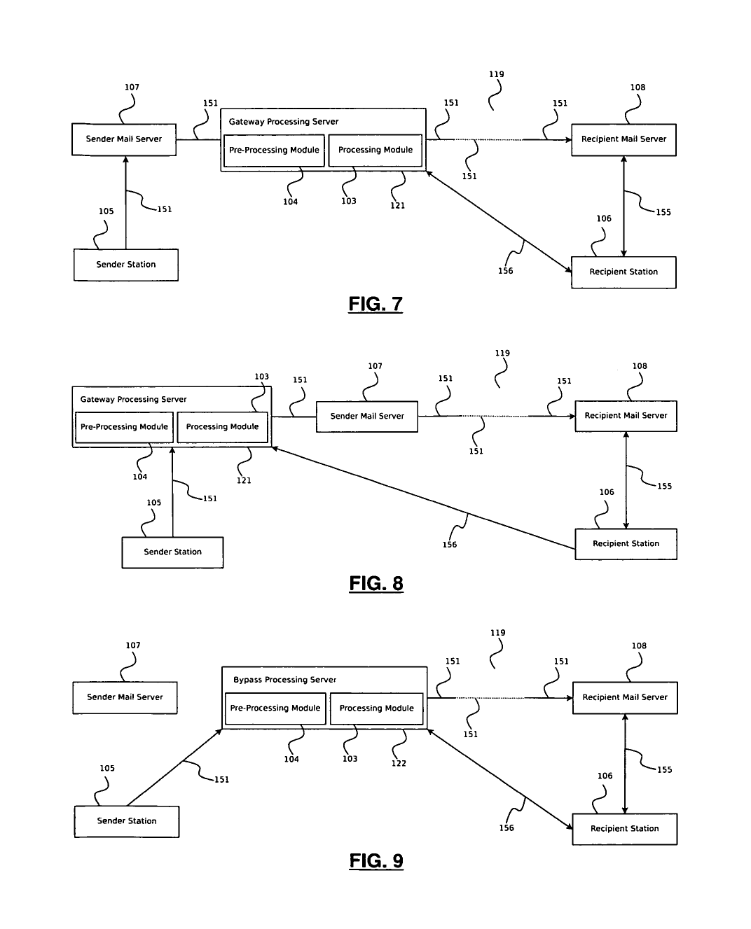

The third set of embodiments is exemplified by FIG. 3. In this set of embodiments, a cryptographically-encoded email sent from the sender unit 101 to the recipient unit 102 (arrow 151) may have been pre-processed in route by the pre-processing module 104 while the recipient unit 102 interacts with the processing module 103 (arrow 152) in a similar fashion as in the first and second set of embodiments. As is illustrated in FIGS. 7 through 11, the pre-processing module 104 would be made to intervene after the cryptographically-encoded email is sent by the sender station 106. In FIGS. 7 and 8 this is done as the email leaves the sender's network, while in 10 and 11 this is done as the email enters the recipient's network, the FIGS. 7, 8 and 10 illustrating the use of a gateway processing server 121. FIG. 9 illustrates another embodiment wherein the pre-processing module 104 is part of a bypass processing server 122 which is used by the sender, typically through manual intervention in his email client application, to transmit all emails which are deemed to require an additional level of security.

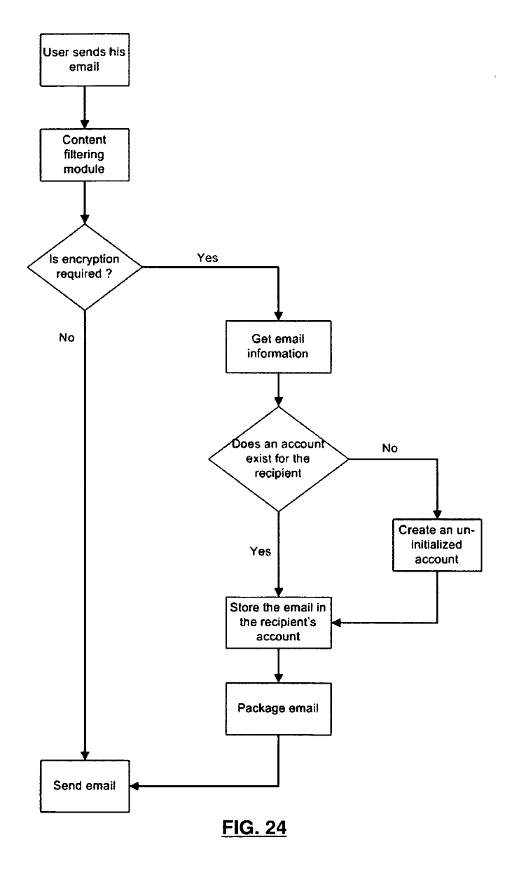

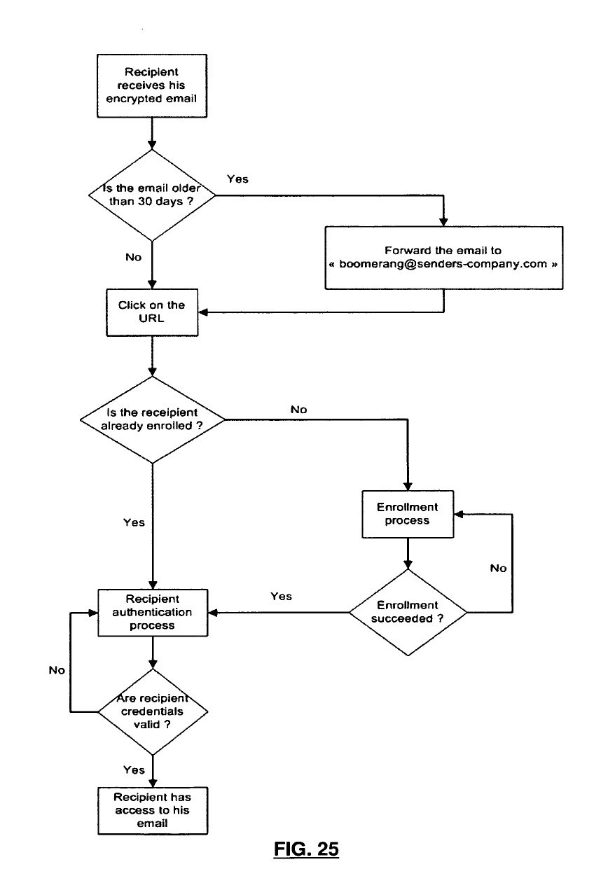

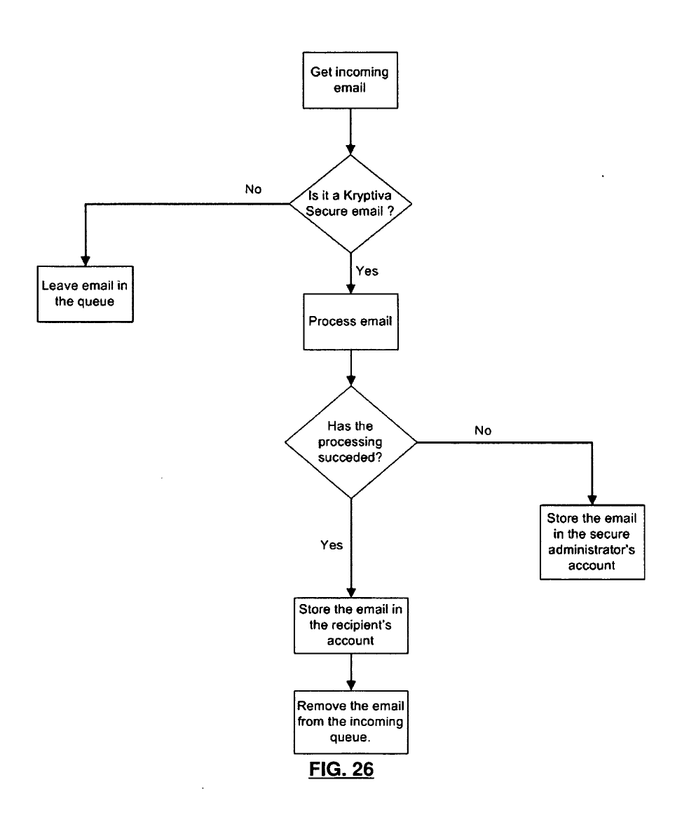

In all these configurations, the pre-processing module 104 would typically be added to an existing product such as a gateway processing server 121 or a bypass processing server 122 and would allow its vendor to enable recipients to view the content of a cryptographically-encoded email even when the contents of said cryptographically-encoded email, which may have been originally made available to the recipient directly through a URL, have been garbage-collected by forwarding the cryptographically-encoded email back to the gateway processing server 121 or the bypass processing server 122. FIG. 24 illustrates the pre-processing module's 104 processing as the email is on its first time through to the recipient, FIG. 25 illustrates the steps performed by the recipient to view his email, and FIG. 26 illustrates the operations done by the pre-processing module 104 to deal with a cryptographically-encoded email forwarded by a recipient.

It will be understood that numerous modifications and changes in form and detail may be made to the embodiments of the presently disclosed system and method for ad-hoc processing of cryptographically-encoded data. It is contemplated that numerous other configurations of the system and method may be used, and the modules of the system and method may be selected from numerous modules other than those specifically disclosed. Therefore, the above description should not be construed as limiting the disclosed system and method, but merely as exemplification of the various embodiments thereof. Those skilled in the art will envisioned numerous modifications within the scope of the present disclosure as defined by the claims appended hereto. In short, it is the intent of the Applicant that the scope of the patent issuing herefrom will be limited only by the scope of the appended claims. Having thus complied with the details and particularity required by the patent laws, what is claimed and desired protected is set forth in the appended claims.

What is claimed is:

1. A system for ad-hoc processing of cryptographically-encoded data, the system comprising:
a sender unit configured for sending cryptographically-encoded data;
a recipient unit configured for receiving data; and
a processing module operating remotely from the recipient unit, the processing module being configured for enabling the recipient unit to decrypt cryptographically-encoded data.

2. A system according to claim 1, wherein the data is an email.

3. A system according to claim 2, wherein the cryptographically-encoded email is submitted for decryption by the recipient unit to the processing module using a copy-and-paste web interface.

4. A system according to claim 2, wherein the cryptographically-encoded email is submitted for decryption by the recipient unit to the processing module by forwarding said cryptographically-encoded email.

5. A system according to claim 2, wherein the processing module requires valid credentials from the recipient unit in order to decrypt the cryptographically-encoded email.

6. A system according to claim 1, further comprising a pre-processing module operating remotely from the sender unit, the pre-processing module being configured for enabling the sender unit to pre-process the cryptographically-encoded data prior to its transmission to the recipient unit.

7. A system according to claim 1, further comprising a pre-processing module operating remotely from the sender unit, the pre-processing being configured for pre-processing the cryptographically-encoded data in transit to the recipient unit.

8. A system according to claim 6, wherein the pre-processing module is separate from the processing module.

9. A system according to claim 7, wherein the pre-processing module is separate from the processing module.

10. A system for ad-hoc processing of cryptographically-encoded email, the system comprising:
a sender station configured for sending a cryptographically-encoded email;
a recipient station configured for receiving email; and
a processing server operating remotely from the recipient station, the processing server being configured for enabling the recipient station to decrypt the cryptographically-encoded email.

11. A system according to claim 10, wherein the cryptographically-encoded email is submitted for decryption by the recipient unit to the processing module by forwarding said cryptographically-encoded email.

12. A method for ad-hoc processing of cryptographically-encoded email, the method comprising:
a) receiving at a processing module a cryptographically-encoded email forwarded by a recipient unit;
b) storing the cryptographically-encoded email in temporary storage; and
c) sending an email to the recipient unit containing a link to a web page for processing the temporarily-stored cryptographically-encoded email.

13. A method according to claim 12, the method further comprising the steps of:
a) interacting with the recipient unit following a visit to the link sent to the recipient unit as a result of having received the forwarded cryptographically-encoded email; and
b) enabling the recipient unit to decrypt the temporarily-stored cryptographically-encoded email.

14. A method for ad-hoc processing of cryptographically-encoded email, the method comprising:
a) providing at a processing module a web interface for a recipient unit to copy-and-paste a cryptographically-encoded email;
b) receiving a copied-and-pasted cryptographically-encoded email; and
c) decrypting the cryptographically-encoded email on behalf of the recipient unit.

15. A method of claim 12, the method further comprising the steps of:
a) forwarding from a pre-processing module the cryptographically-encoded email to the processing module on behalf of the recipient unit;
b) receiving the link sent by the processing module in response to the forwarding of the cryptographically-encoded email; and
c) sending the link to the recipient unit.

16. An article of manufacture for processing a cryptographically-encoded email, wherein the article of manufacture causes operations, the operations comprising:
a) receiving a cryptographically-encoded email forwarded by a recipient station;
b) storing the cryptographically-encoded email in temporary storage; and
c) sending an email to the recipient station containing a link to a web page for processing the temporarily-stored cryptographically-encoded email.

17. An article of manufacture according to claim 16, wherein the article of manufacture further causes the operations of:
a) interacting with the recipient station following a visit to the link sent to the recipient station as a result of having received the forwarded cryptographically-encoded email; and
b) enabling the recipient station to decrypt the temporarily-stored cryptographically-encoded email.
